(19) United States
(12) Patent Application Publication
(10) Pub. No.: US 2021/0006087 A1
(43) Pub. Date: Jan. 7, 2021

(54) CHARGING METHOD AND CHARGER

(71) Applicant: SZ DJI TECHNOLOGY CO., LTD., Shenzhen (CN)

(72) Inventors: Jie TIAN, Shenzhen (CN); Guofu ZHANG, Shenzhen (CN); Wentao WANG, Shenzhen (CN)

(21) Appl. No.: 17/025,870

(22) Filed: Sep. 18, 2020

Related U.S. Application Data
(63) Continuation of application No. PCT/CN2018/079496, filed on Mar. 19, 2018.

(51) Int. Cl. H02J 7/00

(52) U.S. Cl. CPC H02J 7/00714; H02J 7/00034; H02J 7/007182; H02J 7/00304

(57) ABSTRACT

A charging method includes obtaining a working state of a present power adapter connected to a charger through a physical interface, in response to the working state of the present power adapter being an overcurrent protection state, continuing to supply power to a charging control circuit of the charger through a backup power of the charger, and reducing, via the charging control circuit, a present current output by the charger until the working state of the present power adapter returns to normal.

### CROSS-REFERENCE TO RELATED APPLICATION

This application is a continuation of International Application No. PCT/CN2018/079496, filed Mar. 19, 2018, the entire content of which is incorporated herein by reference.

### TECHNICAL FIELD

The present disclosure generally relates to the charging technology field and, more particularly, to a charging method and a charger, which uses different types of power adapters to charge a battery.

### BACKGROUND

Battery is more and more widely used nowadays due to advantages such as a simple structure, a simple operation for charging and discharging. Battery plays more and more important role in daily life. For example, in a wearable device such as a cell phone, a tablet, and a wrist band used in people's daily life, a battery with certain capacitance is configured to provide power needed for operating the device.

Although the capacitance of the battery placed in the device becomes larger and larger, the battery is eventually exhausted as use time increases. At this moment, the battery needs to be charged to recover the power of the battery to ensure normal use of the device. In the existing method, for each device, a dedicated power adapter is provided for charging the battery. By charging the battery using the power adapter of the device, safety is ensured for battery charging.

However, by providing the dedicated power adapter for each device, a generalization requirement cannot be satisfied.

### SUMMARY

Embodiments of the present disclosure provide a charging method includes obtaining a working state of a present power adapter connected to a charger through a physical interface, in response to the working state of the present power adapter being an overcurrent protection state, continuing to supply power to a charging control circuit of the charger through a backup power of the charger, and reducing, via the charging control circuit, a present current output by the charger until the working state of the present power adapter returns to normal.

Embodiments of the present disclosure provide a charger including an acquisition circuit, a charging control circuit, a micro-controller unit (MCU), and a backup power. The acquisition circuit is configured to obtain a working state of a present power adapter connected to the charger through a physical interface. The charging control circuit is configured to adjust a present current output by the charger to a battery. The micro-controller unit (MCU) is electrically connected to the present power adapter through the physical interface, and electrically connected to the acquisition circuit and the charging control circuit. The MCU is configured to, in response to the acquisition circuit determining that the working state of the present power adapter is an overcurrent protection state, control the charging control circuit to reduce the present current. The backup power is electrically connected to the MCU and configured to, in response to the first acquisition circuit determining that the working state of the present power adapter is the overcurrent protection state, supply power to the charging control circuit.

### BRIEF DESCRIPTION OF THE DRAWINGS

FIG. 1 illustrates a schematic flowchart of a charging method applicable to different types of power adapters for charging batteries according to some embodiments of the present disclosure.

FIG. 2 illustrates a schematic diagram of a charger for charging batteries according to some embodiments of the present disclosure.

### DETAILED DESCRIPTION OF THE EMBODIMENTS

Some embodiments of the present disclosure are described in detail in connection with accompanying drawings. In the event of no conflict, following embodiments and features of embodiments may be combined with each other.

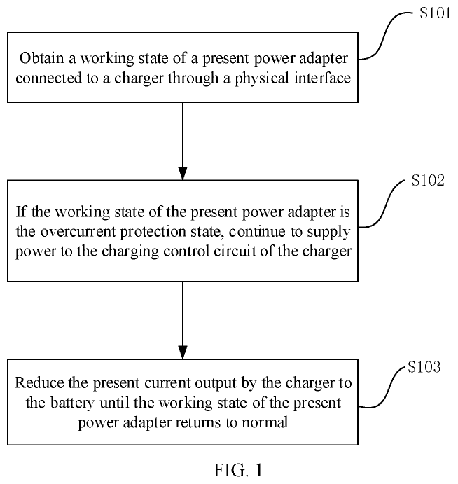

FIG. 1 illustrates a schematic flowchart of a charging method applicable to different types of power adapters for charging a battery according to some embodiments of the present disclosure. As shown in FIG. 1, the charging method of some embodiments includes the following processes.

At S101, a working state of a present power adapter connected to a charger through a physical interface is obtained.

In some embodiments, the power adapter may include a power adapter of any power. For example, the power adapter may include any of the power adapters listed in the following table.

TABLE 1

| No. | Rated Power (W) | Rated Voltage (V) | Rated Current (A) |
|---|---|---|---|
| 1 | 57 | 17.4 | 3.3 |
| 2 | 60 | 17.6 | 3.4 |
| 3 | 100 | 17.4 | 5.74 |
| 4 | 120 | 24 | 5 |
| 5 | 160 | 17.4 | 9.19 |
| 6 | 180 | 26.1 | 6.9 |

When the battery is being charged, the power adapter is connected to the charger described below through the physical interface, such that the current can be transmitted to the battery through the power adapter. In some embodiments, the physical interface for electrically connecting the power adapter to the charger may include a plug/socket (e.g., a pin plug/pin socket), a USB interface, a micro USB interface, a TYPE-C interface, etc.

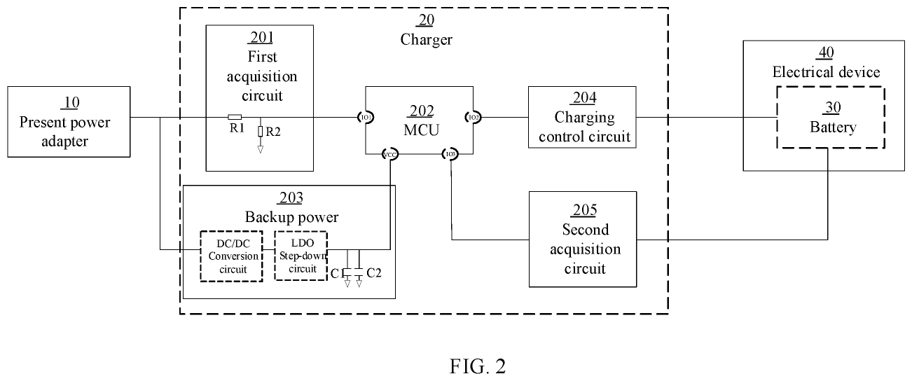

FIG. 2 illustrates a schematic diagram of a charger 20 for charging the battery according to some embodiments of the present disclosure. As shown in FIG. 2, the charger 20 includes a first acquisition circuit 201, a micro-controller unit 202 (MCU 202), a backup power 203, and a charging control circuit 204. The first acquisition circuit 201 is electrically connected to the MCU 202 and is configured to obtain a working state of a power adapter (connected to the charger 20 through the physical interface hereinafter, the power adapter presently electrically connected to the charger 20 through the physical interface is referred to as a present power adapter 10) and transmit the working state to the MCU 202.

In some embodiments, the working state of the present power adapter 10 may include any one of a charging state, an overcurrent protection state, and a stop state. The charging state refers to that the present power adapter 10 transmits utility power to the charger 20 after operations such as AC/DC conversion, filtering, etc. If the charger 20 or the electrical device 40 includes an AC/DC conversion circuit or a filter circuit, the present power adapter 10 may also directly transmit the utility power to the charger 20. Further, when the present power adapter 10 is in the charging state, that is, charges a battery 30, the charging state may include a pre-charging phase, a constant current charging phase, and a constant voltage charging phase. The overcurrent protection state refers to that, when a current for charging the battery 30 is larger than the rated current or preset current of the power adapter, an overcurrent protection circuit of the present power adapter 10 disconnects the charger 20 to avoid burning out the present power adapter 10. In some embodiments, the present power adapter 10 may self-recover to the charging state after a certain time of triggering the overcurrent protection state. The stop state refers to a state that, after the battery 30 is fully charged, the present power adapter 10 no longer transmits power to the battery 30 through the charger 20.

In some embodiments, the first acquisition circuit 201 may directly or indirectly obtain the working state of the present power adapter 10. For example, in some embodiments, the first acquisition circuit 201 may include a voltage sensor, which includes but is not limited to a voltage transformer, a hall voltage sensor, or a fiber optic voltage sensor. The first acquisition circuit 201 may detect the voltage output from the present power adapter 10 to the charger 20 through the above-described voltage sensor. The above-described voltage information may be returned to the MCU 202, such that the MCU 202 may determine the working state of the present power adapter 10 according to the voltage information or changes of the voltage in a certain time period. The following example is used to describe how the MCU 202 determines the working state of the present power adapter 10 by detecting the voltage of the present power adapter 10.

Assume that the voltage output by the present power adapter 10 to the charger 20, which is obtained by the voltage sensor, is reduced to zero, then, the working state of the present power adapter 10 is considered to be the overcurrent protection state. In a specific design, a voltage signal detected by the voltage sensor may be compared with a standard signal. Thus, when the voltage detected by the voltage sensor is reduced to zero, a comparison circuit may transmit a high level or low level signal (e.g., a high level or low level voltage signal, a high level or low level current signal, or any other type of signal) to the MCU 202, such that the MCU 202 may determine that the present power adapter 10 is in the overcurrent protection state.

In other embodiments, a voltage sampling circuit may be configured to obtain the voltage provided by the present power adapter 10 to the charger 10. A voltage signal collected by the voltage sampling circuit is then transmitted to the comparison circuit placed in the MCU 202 or outside the MCU 202, such that the voltage signal can be compared with a standard signal. A comparison result is then transmitted to the MCU 202, such that the MCU 202 can determine the working state of the present power adapter 10 according to the comparison result. In still other embodiments, an output voltage value output by the present power adapter 10 to the charger 20 collected by the voltage sampling circuit may be directly transmitted to the MCU 202. The MCU 202 then can determine the working state of the present power adapter 10 according to the voltage value.

For example, when the voltage, which is collected by the voltage sampling circuit, output by the present power adapter 10 to the charger 20 is reduced to zero, the working state of the present power adapter 10 may be considered to be the overcurrent protection state. When the voltage, which is collected by the voltage sampling circuit, output by the present power adapter 10 to the charger 20 is gradually increased or is stable at a relatively large voltage, the working state of the present power adapter 10 may be considered to be the charging state. When the voltage, which is collected by the voltage sampling circuit, output by the present power adapter 10 to the charger 20 is stable at zero or at a relatively small value in a certain time period, the working state of the present power adapter 10 may be considered to be the stop state.

In some embodiments, a quantity of components and connection relationship thereof in the voltage sampling circuit may be arbitrarily set according to a voltage sampling function that needs to be implemented. FIG. 2 illustrates an optional voltage sampling circuit, which includes a first resistor R1 and a second resistor R2. One terminal of the first resistor R1 is connected to the power adapter, and the other terminal of the first resistor R1 is connected to the MCU 202 and one terminal of the second resistor R2. The other terminal of the second resistor R2 is grounded.

In above-described embodiments, the voltage output by the present power adapter 10 to the charger 20 may be detected by including the voltage sensor and the voltage sampling circuit in the charger 20. Whether the working state of the present power adapter 10 is the overcurrent protection state is determined according to the detected voltage, such that the applicability of the charger 20 of the present disclosure may be increased, and the charging cost may be reduced without modifying the present power adapter. Since the component such as the voltage sensor or the voltage sampling circuit is configured to detect the voltage, the signal can be recognized without the communication connection, and the power adapter has a better versatility.

In some other embodiments, whether the present power adapter 10 is at the overcurrent protection state may be obtained by obtaining the signal transmitted by the present power adapter, which is connected to the charger through the physical interface. In some embodiments, a signal wire, which connects the present power adapter 10 and the charger 20, is provided in the physical interface for connecting the present power adapter 10 and the charger 20. The signal wire may include, e.g., a bus or another wire that may implement communication function. Thus, the signal generated by the present power adapter 10 may be transmitted to the MCU 202 of the charger 20 via the signal wire. Since the signal generated by the present power adapter 10 includes working state information of the present power adapter 10, the MCU 202 only needs to read the signal to recognize the working state information of the present power adapter 10. As such, whether the present power adapter 10 is at the overcurrent protection state is determined.

In some embodiments, to monitor whether the power adapter is connected to the charger 20, a switch may be connected to the voltage sensor or the voltage sampling circuit in series. When the power adapter is connected to the charger 20 through the physical interface, the switch is on. When the power adapter is disconnected from the charger 20, the switch is off. For example, the power adapter and the charger 20 are physically connected through a pin plug/pin socket. Assume that a terminal of the charger 20 is a pin socket, a contact switch may be provided in the pin socket. When the pin plug of the present power adapter is inserted into the pin socket, the contact switch is triggered to turn on. Therefore, the voltage sensor or the voltage sampling circuit can be electrically connected to the present power adapter 10 and the MCU 202 to detect the voltage output by the power adapter to the charger 20. When the pin plug of the power adapter is pulled out of the pin socket from the charger 20, the contact switch is turned off, which short-circuits the voltage sensor or the voltage sampling circuit. Thus, the voltage sensor or voltage sampling circuit does not detect the voltage output from the power adapter to the charger 20. When the signal wire is provided in the physical interface of the power adapter and the charger 20 to communicatively connect the power adapter and the charger 20, the MCU 202 of the charger 20 can determine that the present power adapter 10 is disconnected by only disconnecting the communication connection.

Referring again to FIG. 1, at S102, if the working state of the present power adapter is the overcurrent protection state, the backup power of the charger continues to supply power to the charging control circuit of the charger.

In some embodiments, based on the above description, if the working state of the present power adapter 10 is the overcurrent protection state, the charger 20 is disconnected from the utility power. Therefore, the MCU 202 of the charger 20 is disconnected from the power, and the charging control circuit 204 of the MCU 202 cannot control the charging current. In some embodiments, a backup power 203 is provided in the charger 20. When the working state of the present power adapter 10 is the overcurrent protection state, the backup power 203 continues to supply power to the charging control circuit 204. As such, the charging control circuit 204 can continue to control the charging current, and the disadvantage that the present power adapter 10 cannot control the charging current in the overcurrent protection state is avoided.

In some embodiments, the backup power 203 may be an individual power provided in the charger 20, for example, a button battery 30 placed in the charger 20. In some other embodiments, the backup power 203 may be a temporary energy storage circuit formed by an energy storage component, for example, a capacitor. If the power adapter is connected to the charger 20 through the physical interface, the temporary energy storage circuit is connected to the present power adapter 10 at the same time. Thereby, the present power adapter 10 supplies power to the temporary energy storage circuit, the power is stored in the temporary energy storage circuit. Thus, if the present power adapter 10 detects that the charging current is larger than the rated current or a certain preset value to enter the overcurrent protection state, the temporary energy storage circuit can supply power to the MCU 202 and the charging control circuit 204 to maintain normal functions of the MCU 202 and the charging control circuit 204. Therefore, the charging control circuit 204 may control the charging current.

In some embodiments, as shown in FIG. 2, the backup power 203 includes a first capacitor C1. One terminal of the first capacitor C1 is connected to the present power adapter 10 and a VCC interface of the MCU 202. The other terminal of the first capacitor C1 is grounded. By providing the first capacitor C1 between the present power adapter 10 and the VCC interface of the MCU 202, when the present power adapter 10 is connected to the charger 20 through the physical interface, the first capacitor C1 is charged. If the working state of the present power adapter 10 is the overcurrent protection state, the first capacitor C1 starts to discharge. As such, the first capacitor C1 supplies power to the MCU 202 and the charging control circuit 204 connected to the MCU 202 to maintain the normal functions of the MCU 202 and the charging control circuit 204.

Further, as shown in FIG. 2, the backup power 203 further includes a second capacitor C2 connected to the first capacitor C1 in parallel. By adding the second capacitor C2, the power of the backup power 203 may be adjusted to increase power supply time or power supply current, which is provided by the backup power 203 to the MCU 202 and the charging control circuit 204. To improve the power supply time of the backup power 203 or increase the power supply current of the backup power 203, a plurality of parallelly connected second capacitors C2 may be connected in parallel with the first capacitor C1, or the first capacitor C1 with a larger capacitance may be used.

Since the utility power is usually AC power and has a high voltage, and the electrical device 40 connected to the charger 20 can only withstand a low voltage, in some embodiments, as shown in FIG. 2, the backup power 203 further includes a DC/DC conversion circuit and a step-down circuit. One terminal of the DC/DC conversion circuit is connected to the present power adapter 10, and the other terminal is connected to the step-down circuit. The other terminal of the step-down circuit is connected to one terminal of the first capacitor C1 and the VCC interface of the MCU 202. The other terminal of the first capacitor C1 is grounded. Thus, the DC/DC conversion circuit can isolate the present power adapter 10 and the electrical device 40. At the same time, the DC/DC conversion circuit can adjust the voltage output by the present power adapter 10, which is then provided to the first capacitor C1 (including the second capacitor C2) after the step-down circuit. Therefore, an appropriate charging voltage may be provided to the first capacitor C1 (including the second capacitor C2).

The step-down circuit may be designed according to different needs. In the example shown in FIG. 2, the step-down circuit includes a low dropout regulator (LDO).

In some embodiments, the charging control circuit 204 can include a charging control circuit based on dynamic power management (DPM). In some embodiments, the charging control circuit 204 may include a microprocessor, a micro controller, a digital signal processor, a field programmable gate array, an integrated circuit, etc. In some embodiments, the charging control circuit 204 may control the charging current output by the charger 20 directly based on a digital to analog converter (DAC) signal or a pulse width modulation (PWM) signal output by the MCU 202 or based on filtered DAC signal or PWM signal. In other embodiments, an operation amplifier may be configured to control the charging current output by the charger 20 to the battery 30, for example, reduce the present current output by the charger 20 to the battery 30.

Referring again to FIG. 1, at S103, the charging control circuit reduces the present current output by the charger to the battery until the working state of the present power adapter returns to normal.

In some embodiments, the charging control circuit 204 may reduce the present current output by the charger 20 to the battery 30 by using any kinds of methods. For example, the charging control circuit 204 may adjust a duty ratio or resistance of a current limiting resistor to reduce the present current.

An example charging method that reduces the present current output by the charger 20 to the battery 30 is described below.

Assume that, after the present power adapter 10 is connected to the charger 20 through the physical interface, the present power adapter 10 enters the overcurrent protection state since an initial charging current is larger than the rated current or the preset value of the present power adapter 10. After obtaining that the present power adapter 10 is in the overcurrent protection state, the first acquisition circuit 201 supplies power to the MCU 202 and the charging control circuit 204 through the backup power 203 placed in the charger 20. When the backup power 203 of the charger 20 supplies power to the charging control circuit 204, a first charging current, which is obtained after the charging control circuit 204 reduces the initial charging current when the present power adapter 10 enters the overcurrent protection state by a first preset value, is used as the present current output by the charger 20 to the battery 30. The first charging current described above is also referred to as a “first reduced charging current.” As such, after returning from the overcurrent protection state, the present power adapter 10 may use the reduced first charging current as the present current to charge the battery 30.

After reducing the first preset value, if the first charging current is still larger than the rated current or the preset value of the present power adapter 10, the present power adapter 10 enters the overcurrent protection state a second time after returning from the overcurrent protection state. Since the present power adapter 10 enters the overcurrent protection state a second time, the backup power 203 continues to supply power to the MCU 202 and the charging control circuit 204. The charging control circuit 204 reduces the first charging current by a second preset value (the second preset value may equal the first preset value) to obtain a second charging current (also referred to as a “second reduced charging current”), which is used as the present current output by the charger 20 to the battery 30. As such, after returning from the second overcurrent protection state, the present power adapter 10 may use the second charging current obtained by reducing the first preset value and the second preset value from the initial charging current as the present current to charge the battery 30.

If the second charging current is still larger than the rated current or the preset value of the present power adapter 10, the backup power 203 continues to supply power to the MCU 202 and the charging control circuit 204. Thus, the charging control circuit 204 continues to reduce the charging current output by the charger 20 to the battery 30, until the working state of the present power adapter 10 returns to normal, such that the battery can be charged continuously until the battery 30 is fully charged, or the present power adapter 10 is disconnected from the charger 20.

In some embodiments, the initial charging current may be any value, which can be input by a user or directly hard coded in the MCU 202 or the charging control circuit 204. In other embodiments, the initial charging current may be the same as the rated charging current of the battery 30. In some embodiments, the rated charging current of the to-be-charged battery 30 is obtained by a second acquisition circuit 205 of the charger 20. Then, the rated charging current of the battery 30 is set as the initial charging current of the battery 30.

Since the above-described charging method performs multi-level control on the current output by the charger 20 to the battery 30, to reduce a control time, the first preset value and the second preset value may be set slightly larger. As such, the present power adapter 10 can charge the battery 30 normally by controlling the charging current output by the charger 20 to the battery 30 for one or two times, until the battery 30 is fully charged. When the first preset value and the second preset value are determined, the second preset value may be set smaller than the first preset value, such that the battery 30 is ensured to be charged with a larger current as much as possible, the charging time of the battery 30 is reduced, and the charging efficiency is improved.

In the charging method provided by the present disclosure, if the present power adapter 10 does not match the battery 30, the present power adapter 10 enters the overcurrent protection state. The backup power 203 of the charger 20 may continue to supply power to the charging control circuit 204 to ensure the charging current under control, such that the charging control circuit 204 can reduce the present current output by the charger 20 to the battery 30 to enable that the power adapter not matching the battery 30 can also charge the battery 30. That is, the charging method of the present disclosure may be applicable to any type of power adapter for charging the battery 30. In addition, although when the power adapter does not match the battery 30, the charging control circuit 204 can reduce the current output to the battery 30, the current as large as possible can still be used to charge the battery 30 to save charging time and improve charging efficiency.

The charger 20 consistent with the disclosure is further described in connection with FIG. 2. The charger 20 includes the first acquisition circuit 201, the charging control circuit 204, the MCU 202, and the backup power 203. The first acquisition circuit 201 is configured to obtain the working state of the present power adapter 10 connected to the charger 20 through the physical interface. The charging control circuit 204 is configured to adjust the present current output by the charger 20 to the battery 30. The MCU 202 is electrically connected to the present power adapter 10 through the physical interface and is electrically connected to the first acquisition circuit 201 and the charging control circuit 204. The MCU 202 is configured to, when the first acquisition circuit 201 obtains that the working state of the present power adapter 10 is the overcurrent protection state, control the charging control circuit 204 to reduce the present current output to the battery 30. The backup power 203 is connected to the MCU 202 and is configured to, when the first acquisition circuit 201 detects that the working state of the present power adapter 10 is the overcurrent protection state, supply power to the charging control circuit 204.

In some embodiments, the first acquisition circuit 201 may include a voltage sensor or a voltage sampling circuit. The first acquisition circuit 201 is configured to obtain the output voltage output by the present power adapter 10 to the charger 20 and determine the working state of the present power adapter 10 according to the voltage. In some embodiments, the voltage sampling circuit includes the first resistor R1 and the second resistor R2. One terminal of the first resistor R1 is connected to the present power adapter 10. The other terminal of the first resistor R1 is connected to a first interface of the MCU 202 and one terminal of the second resistor R2. The other terminal of the second resistor R2 is grounded.

In other embodiments, the first acquisition circuit 201 is configured to obtain the signal transmitted by the present power adapter 10 and transmit the signal back to MCU 202. The signal may include the working state information of the present power adapter 10.

As shown in FIG. 2, the backup power 203 includes the first capacitor C1. One terminal of the first capacitor C1 is connected to the present power adapter 10 and the VCC interface of the MCU 202. The other terminal of the first capacitor C1 is grounded. Optionally, as shown in FIG. 2, the backup power 203 further includes a second capacitor C2. The second capacitor C2 is connected to the first capacitor C1 in parallel. The backup power 203 further includes a DC/DC conversion circuit and an LDO step-down circuit. One terminal of the DC/DC conversion circuit is connected to the present power adapter 10. The other terminal of the DC/DC conversion circuit is connected to one terminal of the LDO step-down circuit. The other terminal of the LDO step-down circuit is connected to one terminal of the first capacitor C1 and the VCC interface of the MCU 202.

The charger 20 further includes the second acquisition circuit 205, which is configured to obtain the rated charging current of the battery 30. Optionally, the MCU 202 is further configured to set the obtained rated charging current of the battery 30 as the initial charging current output by the charger 20 to the battery 30.

Further, the first acquisition circuit 201, the second acquisition circuit 205, the MCU 202, the backup power 203, and the charging control circuit 204 are integrated together. As such, the volume of the charger 20 may be reduced.

Further, the charger 20 may be integrated with the battery 30 together. Therefore, the charger 20 does not need to be produced and sold individually to avoid the charger 20 from being damaged or lost.

In addition, the battery 30 of the present disclosure may be an individual battery, or a battery placed or integrated in the electrical device 40 (e.g., a cell phone with a screen, a remote controller, or a tablet).

Although the advantages associated with certain embodiments of the technology have been described in the context of these embodiments, other embodiments may also include such advantages, and not all embodiments describe all the advantages of the present disclosure in detail. The advantages objectively brought by the technical features in embodiments should be regarded as the advantages of the present disclosure which are different from the existing technology, and all within the scope of the present disclosure.

What is claimed is:

1. A charging method comprising:
obtaining a working state of a present power adapter connected to a charger through a physical interface;
in response to the working state of the present power adapter being an overcurrent protection state, continuing to supply power to a charging control circuit of the charger through a backup power of the charger; and
reducing, via the charging control circuit, a present current output by the charger until the working state of the present power adapter returns to normal.

2. The method of claim 1, wherein obtaining the working state of the present power adapter includes:
obtaining an output voltage output by the present power adapter to the charger; and
determining the working state of the present power adapter according to the output voltage.

3. The method of claim 2, wherein determining the working state of the present power adapter according to the output voltage includes:
in response to the output voltage being reduced to zero, determining that the present power adapter is in the overcurrent protection state.

4. The method of claim 1, wherein obtaining the working state of the present power adapter includes:
obtaining a signal transmitted by the present power adapter, the signal including working state information of the present power adapter.

5. The method of claim 1, further comprising:
obtaining a rated charging current of the battery; and
setting the rated charging current of the battery as an initial charging current of the battery.

6. The method of claim 1, wherein reducing the present current output by the charger includes:
reducing, via the charging control unit, the present current from the initial charging current by a preset value to a reduced charging current.

7. The method of claim 6, wherein:
the preset value is a first preset value and the reduced charging current is a first reduced charging current; and
reducing the present current output by the charger further includes:
in response to determining that the working state of the present power adapter is the overcurrent protection state while the first reduced charging current is used to charge the battery, further reducing the present current from the first reduced charging current by a second preset value to a second reduced charging current.

8. The method of claim 7, wherein the second preset value is equal to or smaller than the first preset value.

9. A charger comprising:
an acquisition circuit configured to obtain a working state of a present power adapter connected to the charger through a physical interface;
a charging control circuit configured to adjust a present current output by the charger to a battery;
a micro-controller unit (MCU) electrically connected to the present power adapter through the physical interface, and electrically connected to the acquisition circuit and the charging control circuit, the MCU being configured to, in response to the acquisition circuit determining that the working state of the present power adapter is an overcurrent protection state, control the charging control circuit to reduce the present current; and
a backup power electrically connected to the MCU and configured to, in response to the first acquisition circuit determining that the working state of the present power adapter is the overcurrent protection state, supply power to the charging control circuit.

10. The charger of claim 9, wherein the acquisition circuit includes a voltage sensor or a voltage sampling circuit and is configured to:
obtain an output voltage output by the present power adapter to the charger; and
determine the working state of the present power adapter according to the output voltage.

11. The charger of claim 10, wherein the present power adapter being in the overcurrent protection state includes the output voltage being reduced to zero.

12. The charger of claim 10, wherein:
the acquisition circuit includes the voltage sampling circuit that includes a first resistor and a second resistor;
one terminal of the first resistor is connected to the present power adapter;
another terminal of the first resistor is connected to an interface of the MCU and one terminal of the second resistor;
another terminal of the second resistor is grounded.

13. The charger of claim 9, wherein:
the acquisition circuit is further configured to obtain a signal transmitted by the present power adapter and transmit the signal to the MCU; and
the signal includes working state information of the present power adapter.

14. The charger of claim 9, wherein:
the backup power includes a capacitor;
one terminal of the capacitor is connected to the present power adapter and a VCC interface of the MCU; and
another terminal of the capacitor is grounded.

15. The charger of claim 14, wherein:
the capacitor is a first capacitor; and
the backup power further includes a second capacitor connected to the first capacitor in parallel.

16. The charger of claim 14, wherein:
the backup power further includes a DC/DC conversion circuit and a step-down circuit;
one terminal of the DC/DC conversion circuit is connected to the present power adapter;
another terminal of the DC/DC conversion circuit is connected to one terminal of the step-down circuit; and
another terminal of the step-down circuit is connected to the one terminal of the capacitor and the VCC interface of the MCU.

17. The charger of claim 9,
wherein the acquisition circuit is a first acquisition circuit;
the charger further comprising:
a second acquisition circuit configured to obtain a rated charging current of the battery.

18. The charger of claim 17, wherein the MCU is further configured to set the rated charging current as an initial charging current output by the charger to the battery.

19. The charger of claim 17, wherein the first acquisition circuit, the second acquisition circuit, the MCU, the backup power, and the charging control circuit are integrated together.

20. The charger of claim 9, wherein the charger and the battery are integrated together.
